(19) United States
(12) Patent Application Publication
(10) Pub. No.: US 2009/0313593 A1
(43) Pub. Date: Dec. 17, 2009

(54) Semiconductor integrated circuit design method and semiconductor integrated circuit design apparatus

(75) Inventor: Kenichi Ushiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Microelectronics Limited, Tokyo (JP)

(21) Appl. No.: 12/461,585

(22) Filed: Aug. 17, 2009

Related U.S. Application Data
(63) Continuation of application No. PCT/JP07/55566, filed on Mar. 19, 2007.

(51) Int. Cl. G06F 17/50

(52) U.S. Cl. 716/6; 716/5; 716/12

(57) ABSTRACT

A semiconductor integrated circuit design method includes referring to a best worst coefficient file which stores variation coefficients of capacitance and resistance in each of plural wiring layers under a best condition and a worst condition to form a wiring which is a critical path in a first layer with the smallest variation out of the plural wiring layers, extracting capacitance and resistance corresponding to a wiring layout of the plural wiring layers as a capacitance resistance file, referring to the capacitance resistance file and the best worst coefficient file to generate a best worst capacitance resistance file where capacitance and resistance are defined with taking into consideration the variation on the wiring in each of the plural wiring layers, and performing timing verification of the wiring which is the critical path on the basis of the best worst capacitance resistance file.

This application is a continuing application, filed under 35 U.S.C. §111(a), of International Application PCT/2007/055566, filed on Mar. 19, 2007.

### FIELD

The embodiment discussed herein is related to a semiconductor integrated circuit design method and a semiconductor integrated circuit design apparatus.

### BACKGROUND

When a semiconductor integrated circuit is designed, a delay calculation is performed and timing verification is performed. This timing verification is performed in order to check whether the semiconductor integrated circuit operates at a desired frequency or whether a specified timing value is satisfied. A delay of the semiconductor integrated circuit calculated is influenced by the resistance or capacitance of a wiring. However, the resistance or capacitance of a wiring changes due to, for example, a change in wiring width or length and constant resistance or capacitance is not obtained. Therefore, when a delay calculation or the like is performed, variation in resistance or capacitance is taken into consideration and variation coefficients under the best condition and the worst condition, for example, are used.

An example of a delay calculation in which variation in resistance or capacitance is taken into consideration and in which variation coefficients under the best condition and the worst condition, for example, are used will now be described by the use of the drawings.

FIG. 12 is a flow chart of a conventional semiconductor integrated circuit design method. FIG. 13 illustrates a file including resistance and capacitance and a file including variation coefficients of resistance and capacitance under the best condition and the worst condition. FIG. 14 illustrates a file including resistance and capacitance for which a variation is taken into consideration.

A process will now be described in accordance with a flow chart 300.

After a semiconductor integrated circuit design process is begun, a semiconductor integrated circuit is designed in the order of steps S301 through S308.

[Step S301] Logic synthesis is performed and a net list is generated.

[Step S302] The net list generated is referred to, cells or the like are arranged, and wirings are formed.

[Step S303] It is assumed that the arrangement of the cells or the like and the formation of the wirings are performed in a desired way. Resistance and capacitance (typical resistance and capacitance) are extracted from the cells arranged, the wirings formed, and the like as default values in which there is no variation.

Hereinafter resistance and capacitance will be indicated by “R” and “C,” respectively, in the drawings.

[Step S304] A resistance capacitance file including information regarding the typical resistance and capacitance extracted is generated.

FIG. 13A schematically illustrates a resistance capacitance file. The resistance and capacitance of each wiring net are described in this resistance capacitance file.

[Step S305] A best worst coefficient file 309 which is prepared in advance and which stores variation coefficients of capacitance and resistance under the best condition and the worst condition is referred to, resistance and capacitance for which a variation is taken into consideration are generated from the resistance capacitance file generated, and a best worst resistance capacitance file including resistance and capacitance under the best condition and the worst condition is generated.

FIG. 13B illustrates a best worst coefficient file. In FIG. 13B, “rb” and “rw” are described as variation coefficients of resistance under the best condition and the worst condition, respectively, and “cb” and “cw” are described as variation coefficients of capacitance under the best condition and the worst condition respectively. FIG. 14 schematically illustrates a best worst resistance capacitance file (FIG. 14(A) illustrates a file including resistance and capacitance under the best condition and FIG. 14B illustrates a file including resistance and capacitance under the worst condition). Resistance or capacitance which is obtained by multiplying resistance or capacitance included in the resistance capacitance file (depicted in FIG. 13A) and a variation coefficient under the best condition or the worst condition included in the best worst coefficient file (depicted in FIG. 13B) together and for which a variation is taken into consideration is included in the best worst resistance capacitance file depicted in FIG. 14A or 14B.

[Step S306] The best worst resistance capacitance file generated is referred to and a delay calculation is performed.

[Step S307] A timing analysis is performed on the basis of a result of the delay calculation.

[Step S308] If an error occurs as a result of the timing analysis, then step S302 is performed. If an error does not occur as a result of the timing analysis, then the process ends.

By following the above steps, a variation in resistance or capacitance is taken into consideration, a variation coefficient under the best condition or the worst condition, for example, is used as a variation coefficient, and a delay calculation and semiconductor integrated circuit design are performed.

With the above design process, however, a variation in each of wiring layers which differ in resistance and capacitance is uniformly considered (in this case, a variation coefficient is “1” which is a maximum value). This leads to an excessive assurance. Accordingly, a larger area than is needed is used for forming a semiconductor integrated circuit. In addition, longer turn-around-time (TAT) than is needed is taken at the time of timing convergence. Chip size or costs increase for such reasons.

### SUMMARY

According to one aspect of the present invention, a method for designing a semiconductor integrated circuit having a plurality of wiring layers includes referring to a best worst coefficient file which stores variation coefficients of capacitance and resistance in each of the plurality of wiring layers under a best condition and a worst condition and forming a wiring which is a critical path in a first layer of the plurality of wiring layers in which a variation is the smallest, extracting capacitance and resistance corresponding to a wiring layout on the basis of which wiring is performed in the plurality of wiring layers as a capacitance resistance file, referring to the capacitance resistance file and the best worst coefficient file and generating a best worst capacitance resistance file that defines capacitance and resistance for which variations on the wiring among the plurality of wiring layers are taken into consideration, and performing timing verification of the wiring which is the critical path on the basis of the best worst capacitance resistance file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a flow chart for giving an overview of the present invention;

FIGS. 2A and 2B are schematic views of the formation of a wiring of a semiconductor integrated circuit having a plurality of wirings;

FIG. 3 illustrates the hardware configuration of an apparatus for designing a semiconductor integrated circuit having a plurality of wirings, according to an embodiment;

FIG. 4 is a functional block diagram of the apparatus for designing a semiconductor integrated circuit having a plurality of wirings, according to the embodiment;

FIG. 5 is a flow chart of a procedure for a process performed by the apparatus for designing a semiconductor integrated circuit having a plurality of wirings, according to the embodiment;

FIG. 6 is a flow chart of a procedure for performing arrangement and wiring;

FIG. 7 is a flow chart of a procedure for generating a resistance capacitance file;

FIGS. 8A and 8B illustrate a file which includes resistance and capacitance and which is generated by the semiconductor integrated circuit design apparatus according to the embodiment and a file which includes variation coefficients of resistance and capacitance in each wiring layer under the best condition and the worst condition and which is generated by the semiconductor integrated circuit design apparatus according to the embodiment, respectively;

FIGS. 9A and 9B illustrate a file which includes the resistance and capacitance of clock wiring nets and which is generated by the semiconductor integrated circuit design apparatus according to the embodiment and a file which includes the resistance and capacitance of other wiring nets and which is generated by the semiconductor integrated circuit design apparatus according to the embodiment, respectively;

FIGS. 10A and 10B illustrate files each including the resistance and capacitance of the clock wiring nets for which a variation in each wiring layer is taken into consideration, and generated by the semiconductor integrated circuit design apparatus according to the embodiment;

FIGS. 11A and 11B illustrate files each including the resistance and capacitance of the other wiring nets for which a variation is taken into consideration, and generated by the semiconductor integrated circuit design apparatus according to the embodiment;

FIG. 12 is a flow chart of a conventional semiconductor integrated circuit design method;

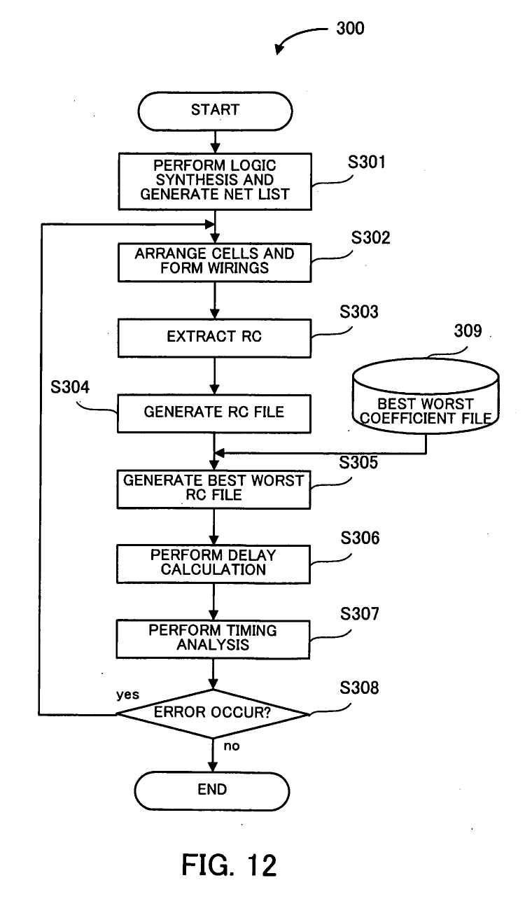

FIGS. 13A and 13B illustrate a file including resistance and capacitance and a file including variation coefficients of resistance and capacitance under the best condition and the worst condition, respectively;

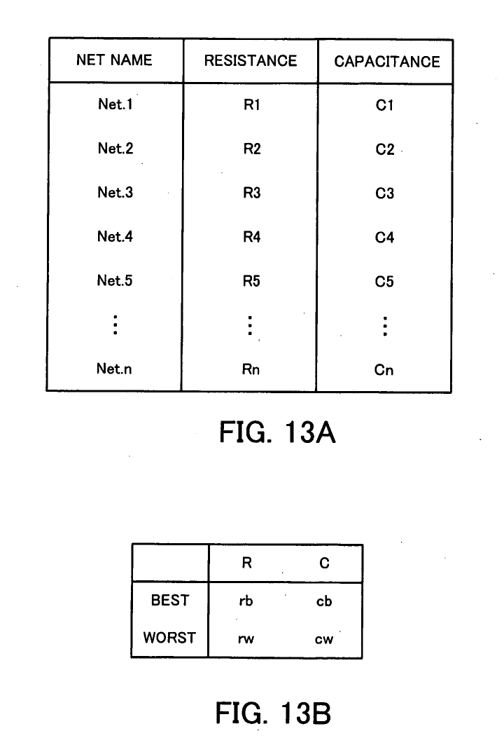

FIGS. 14A and 14B illustrate files each including resistance and capacitance for which a variation is taken into consideration.

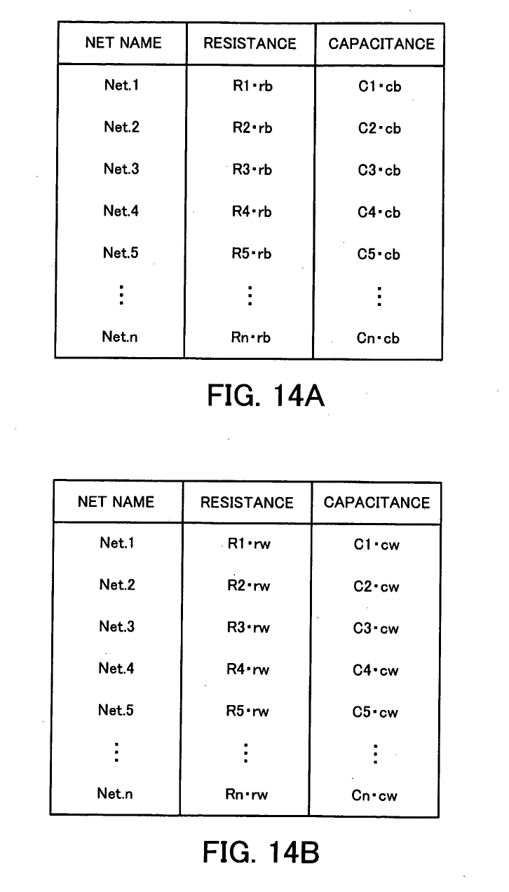

### DESCRIPTION OF EMBODIMENT(S)

Embodiments of the present invention will now be described in detail with reference to the accompanying drawings. However, the technical scope of the present invention is not limited to these embodiments.

An overview of the present invention will be given first and then embodiments of the present invention will be described.

In the present invention a semiconductor integrated circuit design method by which an excessive assurance is avoided is realized by taking a variation in each wiring layer into consideration.

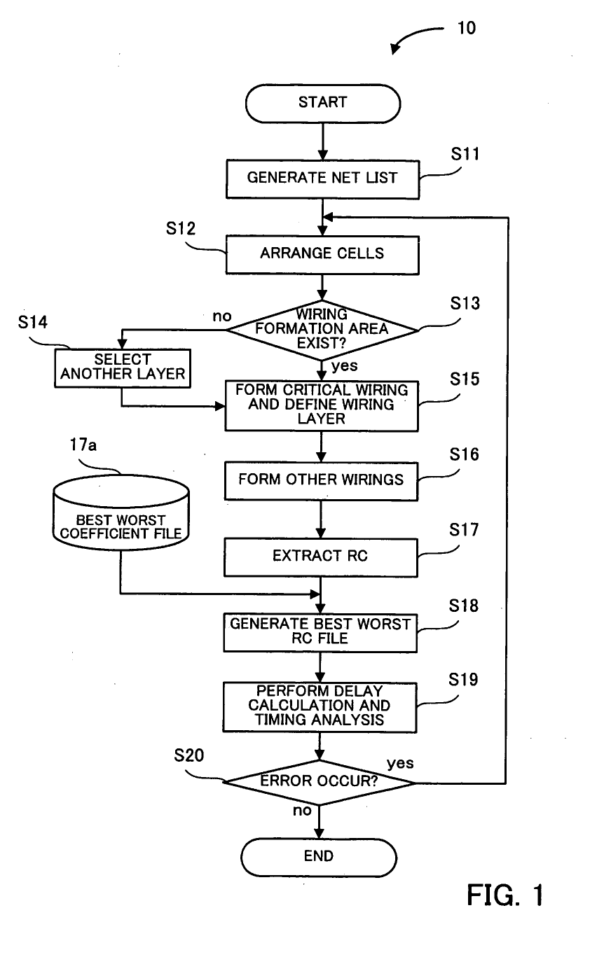

FIG. 1 is a flow chart for giving an overview of the present invention.

A process will now be described in accordance with a flow chart 10.

After the process of designing a semiconductor integrated circuit having a plurality of wiring layers is begun, the semiconductor integrated circuit is designed in the order of steps S11 through S20.

[Step S11] Logic synthesis is performed and a net list is generated.

[Step S12] The net list generated is referred to and cells or the like are arranged.

[Step S13] Whether there is room in a layer in which a variation in the resistance and capacitance of the cells and the like arranged is the smallest to form a critical wiring is determined. If there is not room in the layer in which a variation in the resistance and capacitance of the cells and the like arranged is the smallest to form the critical wiring, then step S14 is performed. If there is room in the layer in which a variation in the resistance and capacitance of the cells and the like arranged is the smallest to form the critical wiring, then the layer in which a variation in the resistance and capacitance of the cells and the like arranged is the smallest is selected and step S15 is performed.

[Step S14] If in step S13 there is not room in the layer in which a variation in the resistance and capacitance of the cells and the like arranged is the smallest to form the critical wiring, then a layer in which a variation in the resistance and capacitance of the cells and the like arranged is the next smallest is selected.

[Step S15] The critical wiring is formed in the layer selected in step S13 or S14. A wiring layer is defined in the layer in which the critical wiring is formed.

[Step S16] Wirings other than the critical wiring are formed.

[Step S17] Typical resistance and capacitance of the critical wiring and the wirings other than the critical wiring are extracted.

[Step S18] A best worst coefficient file 17a regarding variation coefficients under the best condition and the worst condition is referred to and a best worst resistance capacitance file including resistance and capacitance for which a variation is taken into consideration is generated from the typical resistance and capacitance extracted.

[Step S19] The best worst resistance capacitance file generated is referred to and a delay calculation and a timing analysis are performed.

[Step S20] If an error occurs as a result of the timing analysis, then step S12 is performed. If an error does not occur as a result of the timing analysis, then the process ends.

A wiring formed in accordance with the above flow chart 10 will now be described.

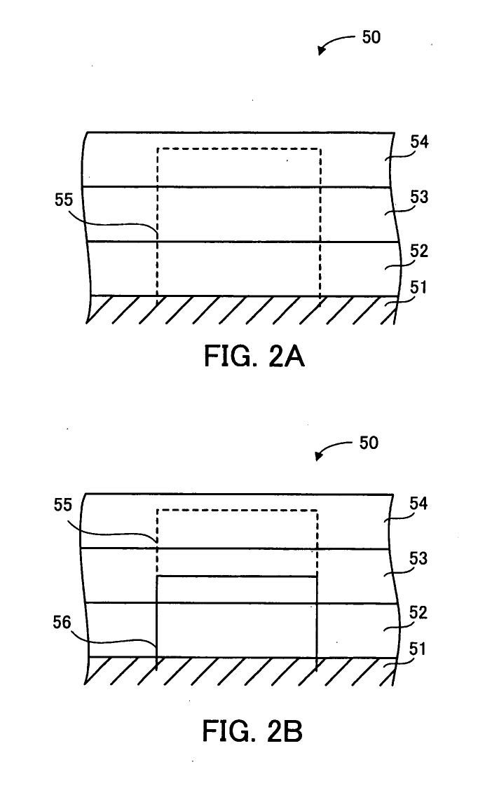

FIGS. 2A and 2B are schematic views of the formation of a wiring of a semiconductor integrated circuit having a plurality of wirings.

In a cell 50, as depicted in FIG. 2A, three layers 52, 53, and 54 are formed over a substrate 51 in that order. A critical wiring 55 is formed in the layer 54 of the cell 50 in which a variation in resistance and capacitance is the smallest. It is assumed that the magnitude of a variation in each layer is given by

variation in layer 54<variation in layer 53<variation in layer 52.

It is assumed that a critical wiring is newly formed in a layer in which a variation is small on a preferential basis. The wiring 55 has already been formed in the layer 54 in which a variation is the smallest, so a wiring cannot be formed in the layer 54. Therefore, the layer 53 in which a variation is the next smallest is selected. By doing so, as depicted in FIG. 2B, a wiring 56 can be formed.

As has been described, when a semiconductor integrated circuit is designed, resistance and capacitance can be estimated with a variation in each wiring layer taken into consideration. As a result, an excessive assurance can be avoided and TAT can be reduced. This prevents an increase in chip size, costs, or the like.

An embodiment will now be described.

A semiconductor integrated circuit design apparatus 100 according to an embodiment is provided. By using the semiconductor integrated circuit design apparatus 100, resistance and capacitance can be extracted with a variation in each wiring layer taken into consideration. In this embodiment, a cell in which a wiring is to be formed includes three areas: a global area, a semi-global area, and an intermediate area from the top.

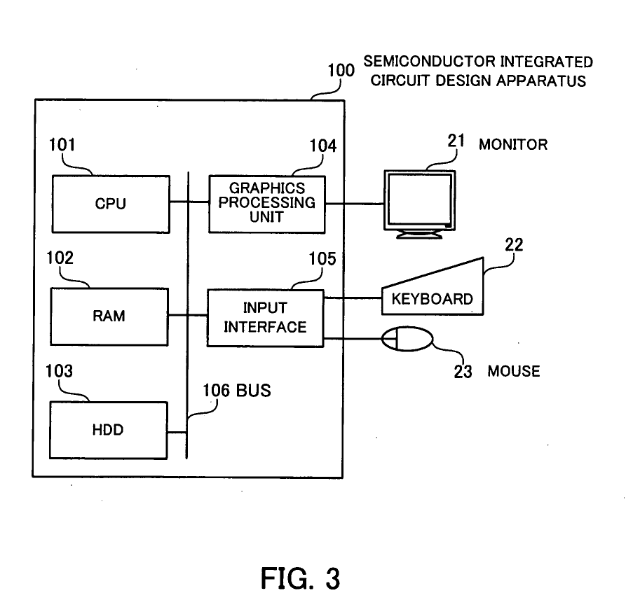

FIG. 3 illustrates the hardware configuration of an apparatus for designing a semiconductor integrated circuit having a plurality of wirings, according to an embodiment.

The whole of a semiconductor integrated circuit design apparatus 100 is controlled by a central processing unit (CPU) 101. A random access memory (RAM) 102, a hard disk drive (HDD) 103, a graphics processing unit 104, and an input interface 105 are connected to the CPU 101 via a bus 106.

The RAM 102 temporarily stores at least part of an operating system (OS) or an application program executed by the CPU 101. The RAM 102 also stores various pieces of data which the CPU 101 needs to perform a process. The HDD 103 stores the OS and application programs.

A monitor 21 is connected to the graphics processing unit 104. In accordance with instructions from the CPU 101, the graphics processing unit 104 displays an image on a screen of the monitor 21.

A keyboard 22 and a mouse 23 are connected to the input interface 105. The input interface 105 sends a signal sent from the keyboard 22 or the mouse 23 to the CPU 101 via the bus 106.

By adopting the above-mentioned hardware configuration, the processing function of this embodiment can be realized.

Functional blocks of the semiconductor integrated circuit design apparatus 100 will now be described.

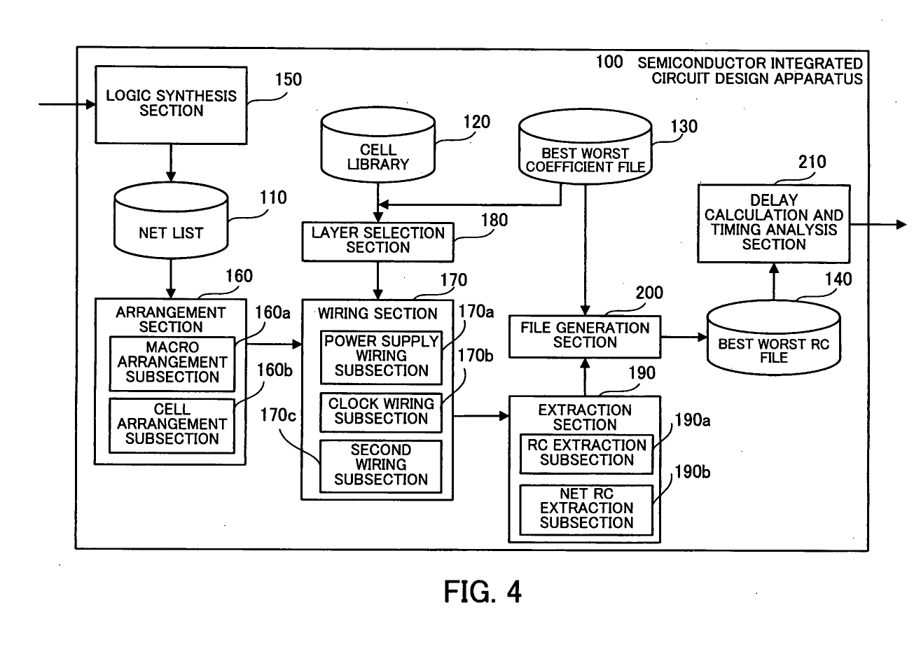

FIG. 4 is a functional block diagram of the apparatus for designing a semiconductor integrated circuit having a plurality of wirings, according to the embodiment.

The semiconductor integrated circuit design apparatus 100 includes a net list 110, a cell library 120, a best worst coefficient file 130, a best worst resistance capacitance file 140, a logic synthesis section 150, an arrangement section 160, a wiring section 170, a layer selection section 180, an extraction section 190, a file generation section 200, and a delay calculation and timing analysis section 210 and can accept input from the outside via the keyboard 22 or the mouse 23. In addition, the logic synthesis section 150 or the delay calculation and timing analysis section 210 can display a process on the screen of the monitor 21.

The logic synthesis section 150 generates the net list 110.

The arrangement section 160 includes a macro arrangement subsection 160a and a cell arrangement subsection 160b and arranges various components of the semiconductor integrated circuit.

The macro arrangement subsection 160a arranges a macro corresponding to a functional block of circuit functions.

The cell arrangement subsection 160b arranges a cell.

The wiring section 170 includes a power supply wiring subsection 170a, a clock wiring subsection 170b, and a second wiring subsection 170c and forms wirings for connecting various components of the semiconductor integrated circuit.

The power supply wiring subsection 170a forms a wiring for supplying power to an LSI.

The clock wiring subsection 170b forms a wiring for transmitting a clock signal as a critical wiring. In addition, the clock wiring subsection 170b determines whether there is room in any layer to form a clock wiring.

The second wiring subsection 170c forms a wiring other than the clock wiring. In addition, the second wiring subsection 170c determines whether there is room in any layer to form a wiring other than the clock wiring.

The layer selection section 180 selects a layer in which the clock wiring and a wiring other than the clock wiring are formed.

The extraction section 190 includes a resistance capacitance extraction subsection 190a and a net resistance capacitance extraction subsection 190b and extracts the resistance and capacitance of a cell, a wiring, or the like arranged.

The resistance capacitance extraction subsection 190a extracts the resistance and capacitance of a cell or a wiring arranged.

The net resistance capacitance extraction subsection 190b extracts the resistance and capacitance of a clock wiring net or a wiring net other than a clock wiring net.

The file generation section 200 generates the best worst resistance capacitance file 140 from the resistance and capacitance extracted by the extraction section 190, variation coefficients of net resistance and capacitance under the best condition and the worst condition obtained by referring to the best worst coefficient file 130, and the like. The file generated will be described later.

The delay calculation and timing analysis section 210 refers to the best worst resistance capacitance file 140 generated by the file generation section 200 and performs a delay calculation and a timing analysis.

The semiconductor integrated circuit is designed in this way. An actual procedure for the process will now be described by the use of a flow chart.

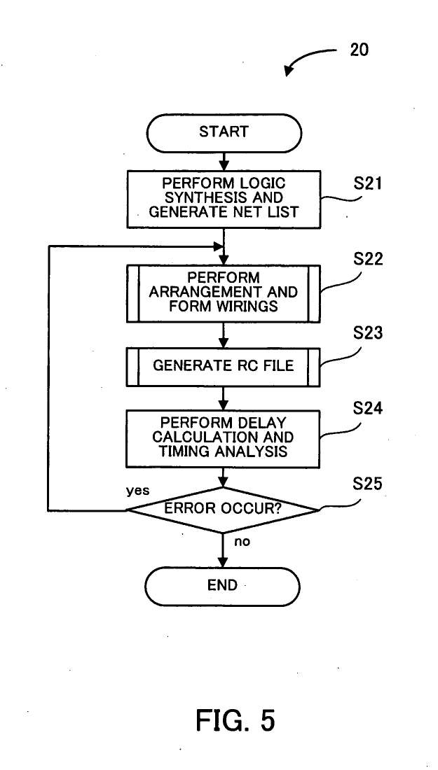

FIG. 5 is a flow chart of a procedure for the process performed by the apparatus for designing a semiconductor integrated circuit having a plurality of wirings, according to the embodiment. The process depicted in FIG. 5 will now be described in order of step number.

[Step S21] The logic synthesis section 150 performs logic synthesis and generates the net list 110.

[Step S22] The arrangement section 160 and the wiring section 170 refer to the net list 110, perform optimization, arrange a macro and a cell, and form the power supply wiring, the clock wiring, and wirings other than the power supply wiring and the clock wiring. Step S22 will be described later in detail.

[Step S23] The file generation section 200 refers to the best worst coefficient file 130 and generates a file including resistance and capacitance for which a variation is taken into consideration on the basis of the resistance and capacitance extracted by the extraction section 190 from the cell, the clock wiring, and the like. By doing so, the best worst resistance capacitance file 140 is generated. Step S23 will be described later in detail.

[Step S24] The delay calculation and timing analysis section 210 refers to the best worst resistance capacitance file 140 generated and performs a delay calculation and a timing analysis.

[Step S25] If an error occurs as a result of the timing analysis, then step S22 is performed. If an error does not occur as a result of the timing analysis, then the process ends.

Steps S22 and S23 included in the above procedure for the process performed by the apparatus for designing a semiconductor integrated circuit having a plurality of wirings will now be described in detail.

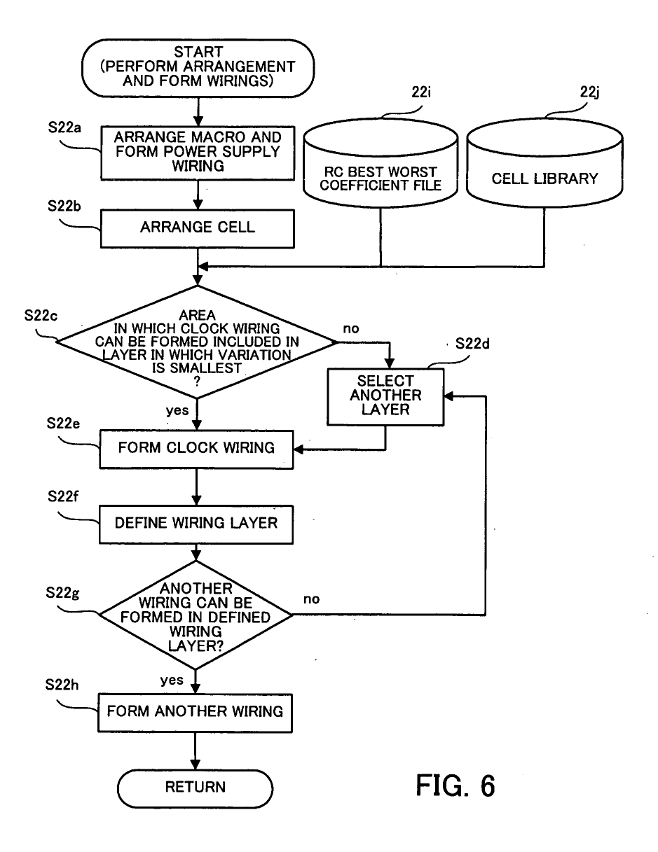

FIG. 6 is a flow chart of a procedure for performing arrangement and wiring. The procedure depicted in FIG. 6 will now be described in order of step number.

[Step S22a] The macro arrangement subsection 160a refers to the net list 110 and arranges a macro. The power supply wiring subsection 170a refers to the net list 110 and forms the wiring for supplying power.

[Step S22b] The cell arrangement subsection 160b refers to the net list 110 and arranges a cell.

[Step S22c] The clock wiring subsection 170b refers to a resistance capacitance best worst coefficient file 22i which stores variation coefficients of resistance and capacitance in each wiring layer under the best condition and the worst condition and a semiconductor integrated circuit cell library 22j and determines whether an area in which the clock wiring for transmitting a clock signal can be formed is included in a layer in which a variation in the resistance and capacitance of the cell arranged is the smallest. If an area in which the clock wiring for transmitting a clock signal can be formed is not included in the layer in which a variation in the resistance and capacitance of the cell arranged is the smallest, then step S22d is performed. If an area in which the clock wiring for transmitting a clock signal can be formed is included in the layer in which a variation in the resistance and capacitance of the cell arranged is the smallest, then this layer is selected and step S22e is performed.

[Step s22d] If an area in which the clock wiring for transmitting a clock signal can be formed is not included in the layer in which a variation in the resistance and capacitance of the cell arranged is the smallest, then the layer selection section 180 selects another layer in which a variation is the next smallest.

[Step S22e] The clock wiring subsection 170b forms the clock wiring in the layer selected in step S22c or S22d.

[Step S22f] The clock wiring subsection 170b defines a wiring layer in the layer in which the clock wiring is formed.

[Step S22g] The clock wiring subsection 170b determines whether a wiring other than the clock wiring can be formed in the defined wiring layer. If a wiring other than the clock wiring can be formed in the defined wiring layer, then step S22h is performed. If a wiring other than the clock wiring cannot be formed in the defined wiring layer, then step S22d is performed.

[Step S22h] The second wiring subsection 170c forms a wiring other than the clock wiring in the wiring layer defined in step S22f.

Arrangement and wiring are performed in accordance with the above procedure to design the semiconductor integrated circuit.

After arrangement and wiring are performed to design the semiconductor integrated circuit, a file including resistance and capacitance for which variation is taken into consideration is generated. This file generation will now be described.

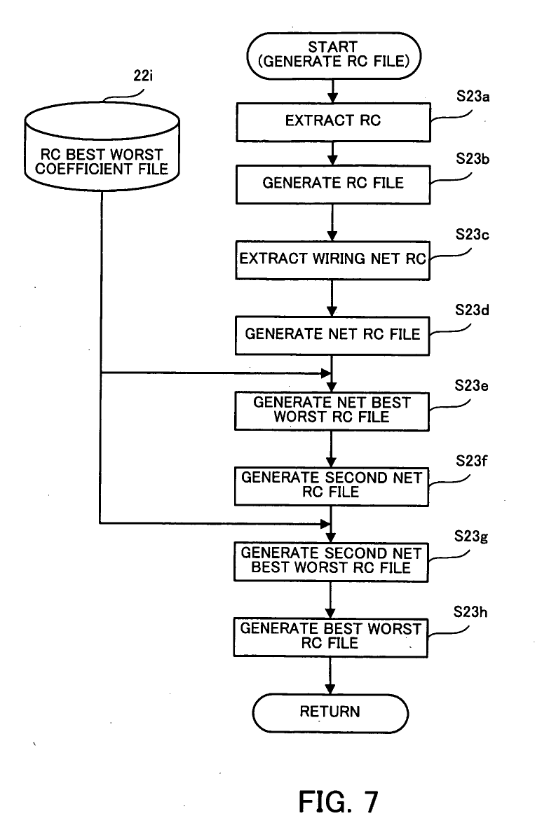

FIG. 7 is a flow chart of a procedure for generating a resistance capacitance file. The procedure depicted in FIG. 7 will now be described in order of step number.

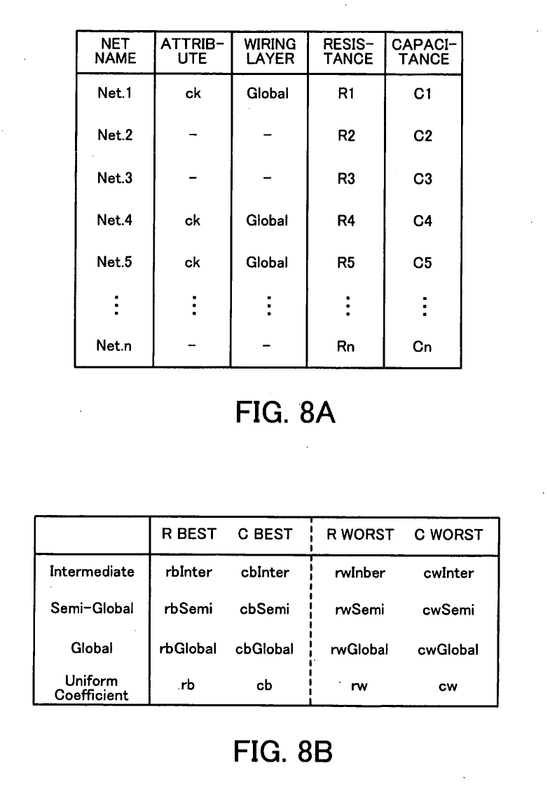

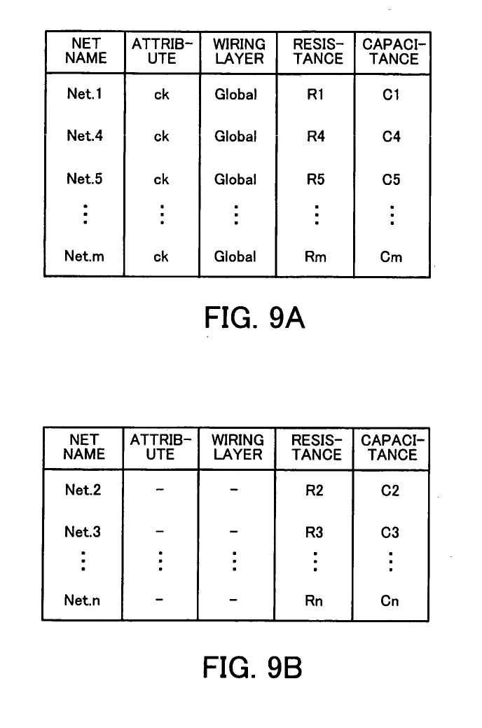

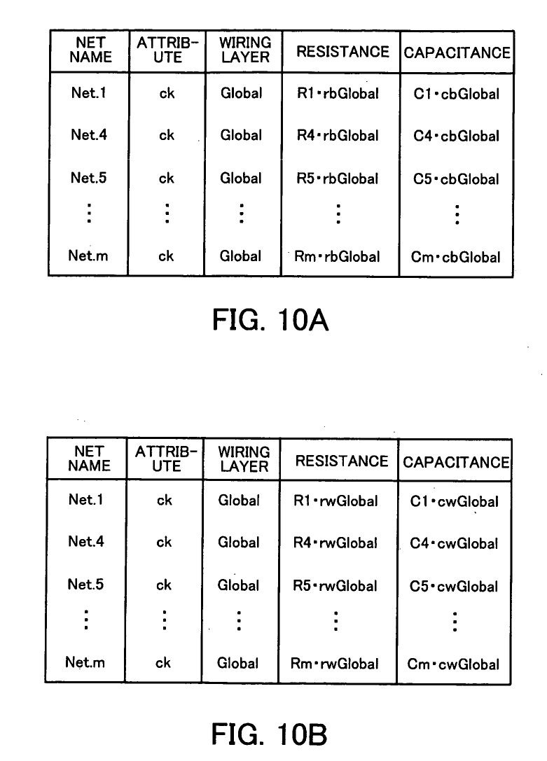

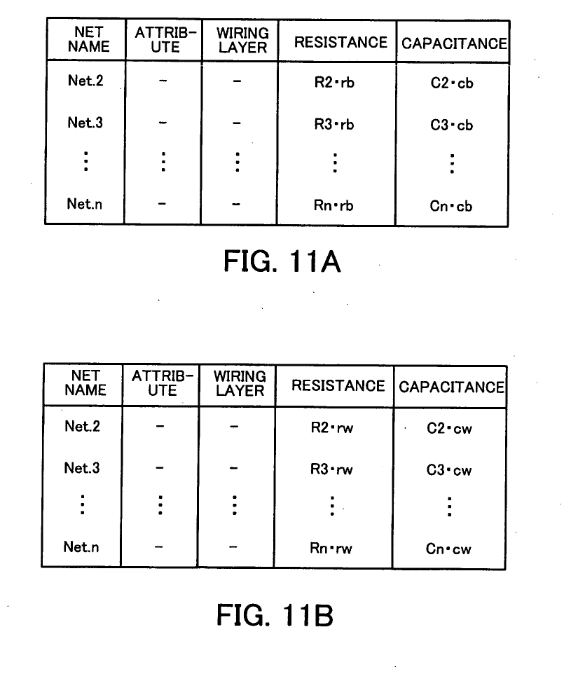

FIGS. 8A and 8B illustrate a file which includes resistance and capacitance and which is generated by the semiconductor integrated circuit design apparatus according to the embodiment and a file which includes variation coefficients of resistance and capacitance in each wiring layer under the best condition and the worst condition and which is generated by the semiconductor integrated circuit design apparatus according to the embodiment, respectively. FIGS. 9A and 9B illustrate a file which includes the resistance and capacitance of clock wiring nets and which is generated by the semiconductor integrated circuit design apparatus according to the embodiment and a file which includes the resistance and capacitance of other wiring nets and which is generated by the semiconductor integrated circuit design apparatus according to the embodiment, respectively. FIGS. 10A and 10B illustrate files each including the resistance and capacitance of the clock wiring nets for which a variation in each wiring layer is taken into consideration, and generated by the semiconductor integrated circuit design apparatus according to the embodiment. FIGS. 11A and 11B illustrate files each including the resistance and capacitance of the other wiring nets for which a variation is taken into consideration, and generated by the semiconductor integrated circuit design apparatus according to the embodiment.

[Step S23a] The resistance capacitance extraction subsection 190a extracts typical resistance and capacitance from the cell, the clock wiring, and the like arranged or formed in step S22.

[Step S23b] As depicted in FIG. 8A, the file generation section 200 generates a resistance capacitance file including the extracted typical resistance and capacitance. According to FIG. 8A, the resistance capacitance file includes an attribute, a wiring layer, resistance, and capacitance for each net. In the case of a file depicted in FIG. 8B, a cell is divided into three areas: an upper layer, a middle layer, and a lower layer. The file depicted in FIG. 8B includes variation coefficients of resistance and capacitance in each layer under the best condition and the worst condition, and variation coefficients of resistance and capacitance under the best condition and the worst condition which are uniform in the entire cell. Variation coefficients of resistance and capacitance in the global area (upper layer) under the best condition are the lowest, and variation coefficients of resistance and capacitance in the intermediate area (lower layer) under the best condition are the highest. Variation coefficients of resistance and capacitance in the intermediate area (lower layer) under the worst condition are the highest and variation coefficients of resistance and capacitance in the global area (upper layer) under the worst condition are the lowest. In FIG. 8B, it is assumed that rbInter=rb, that cbInter=cb, that rwInter=rw, and that cwInter=cw.

[Step S23c] The net resistance capacitance extraction subsection 190b extracts resistance and capacitance from clock wiring nets and wiring nets other than the clock wiring nets.

[Step S23d] The file generation section 200 generates a net resistance capacitance file which is depicted in FIG. 9A and which includes the extracted resistance and capacitance of the clock wiring nets. According to FIG. 9A, the net resistance capacitance file includes an attribute, a wiring layer, resistance, and capacitance for each clock wiring net.

[Step S23e] The file generation section 200 refers to the resistance capacitance best worst coefficient file 22i and generates a net best worst resistance capacitance file that is depicted in FIGS. 10A and 10B and that includes net resistance and capacitance for which a variation in each wiring layer is taken into consideration from the net resistance capacitance file.

[Step S23f] As depicted in FIG. 9B, the file generation section 200 generates a second net resistance capacitance file including the resistance and capacitance of the wiring nets other than the clock wiring nets.

[Step S23g] The file generation section 200 refers to the resistance capacitance best worst coefficient file 22i and generates a second net best worst resistance capacitance file that is depicted in FIGS. 11A and 11B and that includes the resistance and capacitance of the wiring nets other than the clock wiring nets for which a variation is taken into consideration from the second net resistance capacitance file.

[Step S23h] The file generation section 200 combines the net best worst resistance capacitance file (depicted in FIGS. 10A and 10B) and the second net best worst resistance capacitance file (depicted in FIGS. 11A and 11B) into a best worst resistance capacitance file (not depicted) including the resistance and capacitance of each net for which a variation in each wiring layer is taken into consideration.

A semiconductor integrated circuit is designed by the use of the best worst resistance capacitance file obtained in this way. By doing so, resistance and capacitance can be estimated with a variation in each wiring layer taken into consideration. As a result, an excessive assurance can be avoided and TAT can be shortened. Therefore, an increase in chip size or costs, for example, can be controlled.

According to the present invention, capacitance and resistance corresponding to a wiring layout on the basis of which wiring is performed in a plurality of wiring layers are extracted as a capacitance resistance file, the capacitance resistance file and a best worst coefficient file which stores variation coefficients of capacitance and resistance in each wiring layer under the best condition and the worst condition are referred to, a best worst capacitance resistance file which defines capacitance and resistance for which a variation on the wiring in each wiring layer is taken into consideration is generated, and wiring timing verification is performed on the basis of the best worst capacitance resistance file. By doing so, resistance and capacitance can be estimated with a variation in each wiring layer taken into consideration. As a result, an excessive assurance can be avoided and TAT can be shortened. Therefore, an increase in chip size or costs, for example, can be controlled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions, and alterations could be made hereto without departing from the spirit and scope of the invention.

What is claimed is:

1. A method for designing a semiconductor integrated circuit having a plurality of wiring layers, the method comprising:
referring to a best worst coefficient file which stores variation coefficients of capacitance and resistance in each of the plurality of wiring layers under a best condition and a worst condition and forming a wiring which is a critical path in a first layer of the plurality of wiring layers in which a variation is the smallest;
extracting capacitance and resistance corresponding to a wiring layout on the basis of which wiring is performed in the plurality of wiring layers as a capacitance resistance file;
referring to the capacitance resistance file and the best worst coefficient file and generating a best worst capacitance resistance file that defines capacitance and resistance for which the variation on the wiring in each of the plurality of wiring layers is taken into consideration; and
performing timing verification of the wiring which is the critical path on the basis of the best worst capacitance resistance file.

2. The method according to claim 1, wherein the wiring which is the critical path is a clock wiring for transmitting a clock signal.

3. The method according to claim 1, further comprising:
determining whether an area in which the wiring which is the critical path can be formed is included in the first layer;
selecting, in the case of an area in which the wiring which is the critical path can be formed being included in the first layer, the first layer and forming the wiring which is the critical path;
selecting, in the case of an area in which the wiring which is the critical path can be formed not being included in the first layer, a second layer in which the variation is the next smallest and forming the wiring which is the critical path; and
performing timing verification of the wiring which is the critical path in the layer in which the wiring which is the critical path is formed on the basis of the best worst capacitance resistance file.

4. The method according to claim 1, wherein:
the plurality of wiring layers are divided into a predetermined number of wiring layer groups; and
one of the wiring layer groups is defined as one of the first layer and the second layer.

5. The method according to claim 1, wherein the variation is smaller in a higher layer of the plurality of wiring layers.

6. An apparatus for designing a semiconductor integrated circuit having a plurality of wiring layers, the apparatus comprising:
a wiring section which refers to a best worst coefficient file that stores variation coefficients of capacitance and resistance in each of the plurality of wiring layers under a best condition and a worst condition and which forms a wiring that is a critical path in a first layer of the plurality of wiring layers in which a variation is the smallest;
a section which extracts capacitance and resistance corresponding to a wiring layout on the basis of which wiring is performed in the plurality of wiring layers as a capacitance resistance file;
a section which refers to the capacitance resistance file and the best worst coefficient file and which generates a best worst capacitance resistance file that defines capacitance and resistance for which the variation on the wiring in each of the plurality of wiring layers is taken into consideration; and
a section which performs timing verification of the wiring which is the critical path on the basis of the best worst capacitance resistance file.

7. The apparatus according to claim 6, wherein the wiring which is the critical path is a clock wiring for transmitting a clock signal.

8. The apparatus according to claim 6, wherein:
it is determined determining whether an area in which the wiring which is the critical path can be formed is included in the first layer;
in the case of an area in which the wiring which is the critical path can be formed being included in the first layer, the first layer is selected and the wiring which is the critical path is formed;
in the case of an area in which the wiring which is the critical path can be formed not being included in the first layer, a second layer in which the variation is the next smallest is selected and the wiring which is the critical path is formed; and
timing verification of the wiring which is the critical path in the layer in which the wiring which is the critical path is formed is performed on the basis of the best worst capacitance resistance file.

9. The apparatus according to claim 6, wherein:
the plurality of wiring layers are divided into a predetermined number of wiring layer groups; and
one of the wiring layer groups is defined as one of the first layer and the second layer.

10. The apparatus according to claim 6, wherein the variation is smaller in a higher layer of the plurality of wiring layers included in the semiconductor integrated circuit.
